(19) United States
(12) Patent Application Publication
(10) Pub. No.: US 2024/0248000 A1
(43) Pub. Date: Jul. 25, 2024

(54) Pluggable OTDR With Integrated BOSA

(71) Applicant: II-VI Delaware, Inc., Wilmington, DE (US)

(72) Inventors: Siegfried Fleischer, Wilmington, DE (US); Ian Peter McClean, Wilmington, DE (US)

(21) Appl. No.: 18/101,231

(22) Filed: Jan. 25, 2023

(51) Int. Cl. G01M 11/00; H04B 10/071

(52) U.S. Cl. CPC G01M 11/3109; H04B 10/071

(57) ABSTRACT

An optical time domain reflectometer (OTDR) system comprising a modified BOSA in a single module, that is in a pluggable form factor. The pluggable form factor may be a QSFP format, a QSFP28 format, or an SFP format. The modified BOSA may be operable on a substantially same transmit and receive frequency.

### TECHNICAL FIELD

Disclosed herein are various physical configurations of an optical time domain reflectometer (OTDR) that enable the OTDR to be provided as a pluggable module, such as in a small form factor pluggable (SFP) form.

### BACKGROUND

Aspects of the present disclosure relate to an optical time domain reflectometer (OTDR). Various issues may exist with conventional solutions for OTDRs. In this regard, conventional systems and methods for OTDRs may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims are pluggable OTDRs with integrated BOSA and methods of forming such OTDRs.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 provides a diagram of a conventional OTDR.

FIG. 2 is a diagram of a first embodiment of a pluggable OTDR.

FIG. 3 illustrates an alternative embodiment of a passive OTDR module that may form as part of a pluggable OTDR

FIG. 4 depicts a BOSA and an exemplary functional diagram of it.

FIG. 5 depicts a particular configuration of an OTDR module in pluggable form with an integrated BOSA.

FIG. 6 depicts a particular configuration of an OTDR module in pluggable form with an integrated BOSA and an MSA interface.

FIG. 7 depicts a particular configuration of an OTDR module in pluggable form with an integrated BOSA, coupled to a host card.

### DESCRIPTION

The following discussion provides various examples of a pluggable OTDR with an integrated BOSA. Such examples are non-limiting, and the scope of the appended claims should not be limited to the particular examples disclosed. In the following discussion, the terms “example” and “e.g.” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “or” means any one or more of the items in the list joined by “or”. As an example, “x or y” means any element of the three-element set {(x), (y), (x, y)}. As another example, “x, y, or z” means any element of the seven-element set {(x), (y), (z), (x, y), (x, z), (y, z), (x, y, z)}.

The terms “comprises,” “comprising,” “includes,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

OTDRs are used to determine optical fiber characteristics such as attenuation, reflections, and the like, in order to optimize the working levels of associated transmitter and receiver equipment. An OTDR module typically includes an optical source used to generate a probe lightwave that is coupled into an optical fiber span being analyzed, and an optical receiver for detecting reflected light attributed to the probe lightwave that re-enters the OTDR from the fiber span under evaluation. An associated processing module utilizes information associated with the probe lightwave (e.g., in the case of using probe pulses, the timing information associated with the pulse train) and the optical power in the return back-reflected light to create an output (typically referred to as an OTDR trace) that defines the overall loss along the fiber span, as well as an identification of any physical changes/reflection points (e.g., connectors, splices, and the like) that may be present along the measured span.

While extremely useful in both installation and monitoring of optical fiber links between network nodes, a conventional OTDR requires optics and electronics that cannot simply and/or inexpensively be housed within a pluggable module, as in common use today for various optical components (such as a small form factor optical transceiver). Thus, the OTDR functionality is typically embedded within more complex modules. This integrated approach to providing OTDR functionality limits the flexibility of its use, as well as increasing the cost and size of the larger module component.

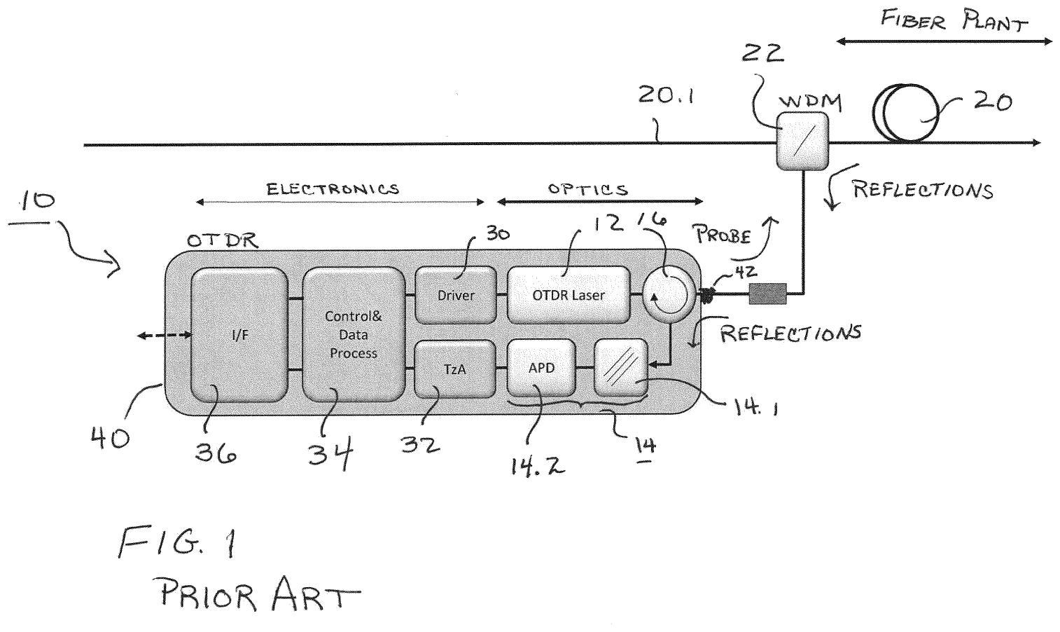

FIG. 1 is a diagram of a conventional OTDR 10. There is shown a fiber plant, coupled to a wavelength division multiplexer (WDM) 22, which is also coupled to a section of fiber 20.1. Furthermore, the WDM 22 is coupled to an OTDR 10.

The fiber plant may comprise an optical fiber span/fiber link 20. A fiber span 20 may be part of an optical fiber communications system providing data connection between two or more points, using fiber optical communications. The section of fiber 20.1 may have similar properties to a fiber link 20. A wavelength division multiplexer (WDM) 22 may be enabled to multiplex a number of optical carrier signals, for example signals using different wavelengths, onto a single optical fiber. An OTDR 10 may be an optical electronic instrument enabled to characterize an optical fiber. For example, an OTDR 10 may inject optical pulses into a fiber under test, e.g., a fiber link 20, via output port 42 and WDM 22, and measure reflected light to obtain properties and information about the optical fiber link 20.

The OTDR 10 may comprise an optical circulator 16 coupled to an output port 42, an optical receiver 14 coupled to the optical circulator 16. The OTDR 10 further comprises an optical transmitter 12 coupled to the optical circulator 16, a driver circuit 30 coupled to the optical transmitter 12, a trans impedance amplifier 32 coupled to the optical receiver 14, a processor element 34 coupled to the trans impedance amplifier 32 and the driver circuit 30, and an electrical interface 36 coupled to the processor element 34. In some instances, these components may be comprised in a single module 40.

An optical circulator 16 may be an optical device with multiple ports operable such that light entering any port exits from the next port in a certain direction. For example, an optical signal entering from port 42 may be communicatively coupled to an optical receiver 14, and an optical signal generated at the optical transmitter 12 may be communicatively coupled to the output port 42. An optical receiver 14 may comprise an optical bandpass filter 14.1 and a photo detector 14.2. An optical receiver 14 may be enabled to receive a light signal and convert it to a corresponding electrical signal. The optical bandpass filter 14.1 may be enabled to block light signals below a lower frequency and block light signals above a higher frequency. The bandpass filter 14.1 in an OTDR 10 may be operable to pass the frequencies identical to those emitted by the optical transmitter 12, in order to permit received reflections to be passed to the photo diode 14.2. The photo detector 14.2 may be for example a photo diode (e.g. an avalanche photo diode) enabled to receive light and output an electric signal.

An optical transmitter 12 may comprise e.g. a laser operable to emit light. A driver circuit 30 may be used to energize the optical transmitter 12. For example, the driver circuit 30 may be configured to provide a pulsed electronic input to the optical transmitter 12, which may cause the optical transmitter 12 to generate light pulses.

The OTDR 10 also comprises electronic elements used to control the operation of transmitter 12 and receiver 14, as well as process the return light from receiver 14 to develop the OTDR trace output.

A transimpedance amplifier (TIA) 32 is shown as coupled to the output from photodetector 14.2 and is used to convert the electrical current from photodetector 14.2 into a voltage waveform useful in further processing.

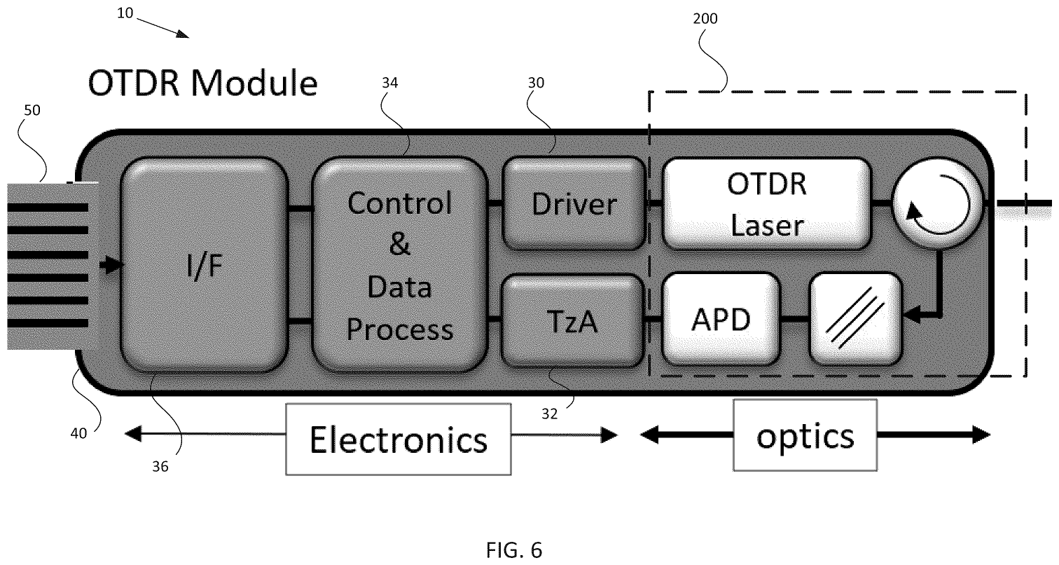

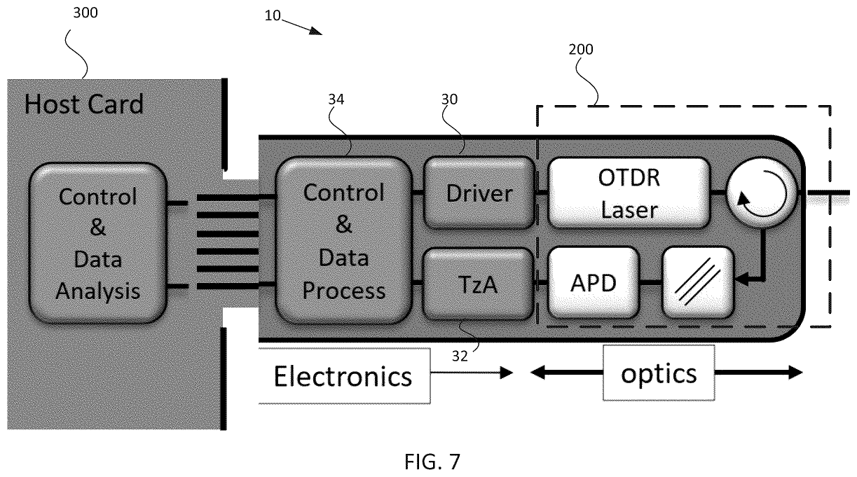

A processor element 34 is used to control operation of laser driver 30 and also analyze the return electrical signals from TIA 32 used to create the OTDR trace. In some instances, as will be discussed below with reference to FIG. 6 and FIG. 7, the processor element 34 may only perform a part of the tasks mentioned above. In accordance with various embodiments of the invention, the processor element 34 may pass on raw measurement data or somewhat processed data for further processing to e.g. a host card 300 or to some other data analysis system via an MSA interface 50. An electrical interface 36 provides bidirectional communication between OTDR 10 and remote monitoring equipment.

The OTDR 10 comprises an optical transmitter 12 for providing an optical probe light wave that is coupled into fiber link 20 and used in a manner well-understood in the art to create back-reflected light in the return direction, where the reflected light is used to generate an OTDR trace as the output from OTDR 10. In many cases, the optical probe signal takes the form of an optical pulse train, but other types of optical probe signals (e.g., continuous-wave signal, a digital signal having a particular coding scheme, etc.) may be used as well.

An optical receiver 14 (in this case taking the form of a bandpass optical filter, 14.1, followed by a photodetector 14.2) is also located in OTDR 10 and is used to measure the back-reflected light created by the optical probe signal as it propagates along fiber link 20. In this particular configuration, an optical circulator 16 is used to control/direct the signal flows between optical transmitter 12, optical receiver 14, and fiber span 20. Various other passive arrangements may be used in place of an optical circulator to control the directions of the propagating signals without affecting the inventive techniques as described below.

The prior art configuration of OTDR 10 is somewhat compact and fully integrated, with all components assembled within a single module 40. A single output port 42 from module 40 provides the optical connection between OTDR 10 and a wavelength division multiplexer (WDM) 22 positioned along fiber span 20. While integration of components is typically a preferred mechanism to achieve improved product designs, in this case the integration may not suffice to provide a pluggable, small form factor component.

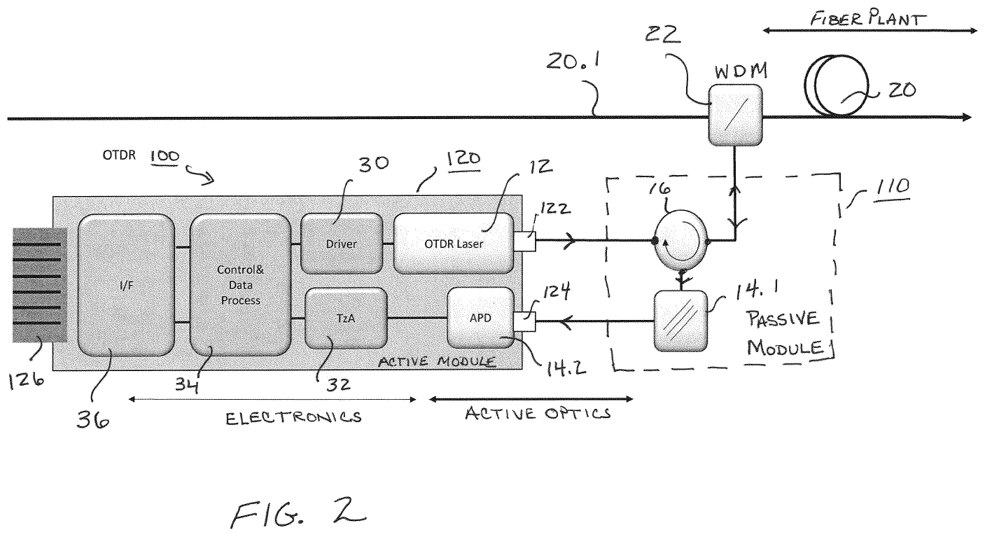

FIG. 2 illustrates a pluggable OTDR. A pluggable OTDR 100 may be configured so that the passive optical components (i.e., circulator 16 and bandpass filter 14.1) are separated from the remaining components and perhaps housed together as a passive OTDR module 110. An active OTDR module 120 is shown as housing the remaining components (with reference to the components also shown in FIG. 1); that is, electro-optic elements including laser 12 and photodetector 14.1, as well as electrical components such as laser driver circuit 30, transimpedance amplifier 32, processor element 34, and interface 36.

A pair of optical ports is included with active module 120, shown as an output port 122 coupled to laser 12 and an input port 124 coupled to photodetector 14.2. The appearance and use of such a dual-port module is common to various SFP (Small Form-factor Pluggable) optical transceiver designs and enhances the capability to configure OTDR 100 as a pluggable arrangement. An electrical interface connection 126 may take the form of a standard connector used with pluggable optical components.

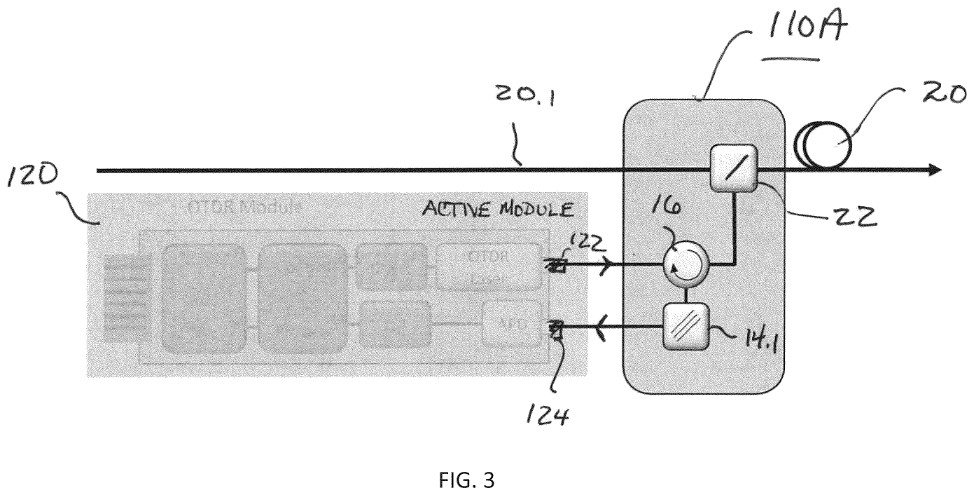

FIG. 3 depicts an alternative configuration for a passive module 110. In this case, a passive module 110A is formed from passive module 110 to also include WDM 22, which may also be a passive component. The integration of these three passive elements (i.e., bandpass filter 14.1, circulator 16, and multiplexer 22) on a single platform/substrate is considered to simplify the implementation of the pluggable OTDR. Indeed, passive module 110A may exhibit a 2×2 fiber pigtail configuration, for example. In use, OTDR active module 120 (shown in phantom in FIG. 3) may simply be “plugged” into fiber pigtail 110A. When not in use, the optical signal propagating along fiber section 20.1 will simply pass through WDM 22 and continue along fiber span 20.

However, even separating passive and active components as illustrated in FIG. 2 and FIG. 3 may not provide sufficient miniaturization for pluggable formats such as QSFP (e.g., QSFP28, quad small form factor pluggable), and it may still necessitate two components, namely e.g., a passive module 110A and an active module 120. For example, to couple the passive discrete optical elements (circulator 16, bandpass filter 14.1, WDM 22) may require optical fibre coupling, where care must be taken not to bend optical fibres in a radius to small, lest they break. Thus, such a passive module 110/110A may still be too large.

It is desirable to further miniaturize such that the entire OTDR may be a single module in a pluggable form factor.

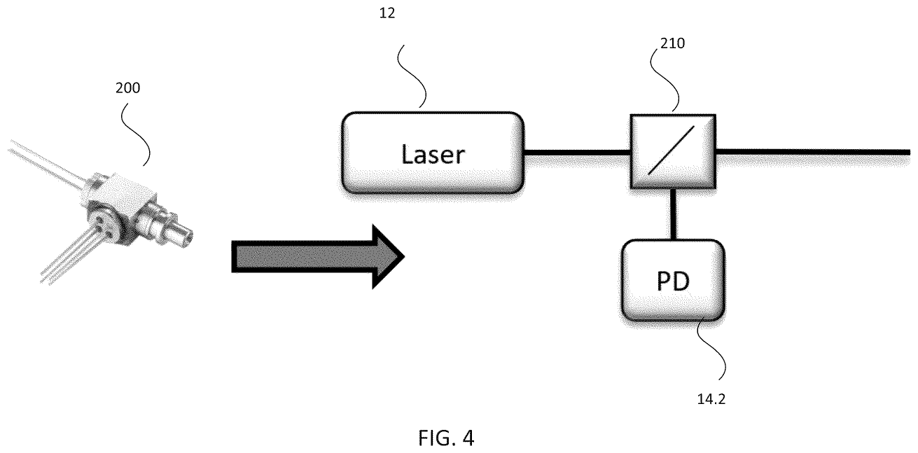

FIG. 4 shows a modified bidirectional optical subassembly (BOSA) 200. The modified BOSA 200 may comprise a laser 12, a directional element 210, and a photo diode 14.2. The directional elements 210 may be a splitter/combiner, or functionally a circulator 16.

The modified BOSA 200 may comprise an optical transmitter 12, for example a laser diode, to convert electrical signals into optical signals. The optical transmitter may be cooled or uncooled, to improve wavelength change over operating temperature. The transmit components of the modified BOSA 200 may be termed a TOSA, transmit optical subassembly. The modified BOSA 200 may further comprise receiving components (receive optical subassembly, ROSA), for example, photo diode 14.2. The optical receiver 14, and specifically the photo diode 14.2, may be cooled or uncooled to improve receiver sensitivity required by an OTDR. Because the modified BOSA 200 may comprise a transmitter and a receiver, it is termed bidirectional.

The directional element 210 may function similarly to a circulator 16 and permit a transmit signal from laser 12 to pass outbound, and permit a receive signal inbound to the photo diode 14.2. However, it may be implemented with a WDM filter for size constraints, instead of a circulator. Note, that prior art BOSA 200 are operable with a transmitter 12 generating light of a different wavelength from the light received at the optical receiver, i.e. the photo diode 14.2, intended to be used for bidirectional communications on different uplink and downlink wavelengths. In the prior art, the transmit frequency may be desired to be different from the receive frequency in a prior art BOSA 200.

In accordance with various embodiments of the invention, the modified BOSA 200 may be operable such that the transmit frequency emitted from laser 12 may be substantially identical to the frequencies that may be received at the photo diode 14.2. This may be desirable in an OTDR, because the optical probe signal will be reflected in the fiber span 20 and the reflections may be substantially the same as a delayed and attenuated probe signal, and needs to be detected at the photo diode 14.2. Correspondingly, the laser 12 and the photo diode 14.2 may be tuned to the substantially same frequency.

A modified BOSA 200, constructed in accordance with various embodiments of the invention, specifically operable at a substantially identical transmit frequency and receive frequency, may substitute the optical transmitter 12, the circulator 16, and the optical receiver 14, as shown in FIG. 1. Because such a modified BOSA 200 may be much smaller than discrete components (particularly a conventional circulator 16), even if highly miniaturized, the invention may permit an OTDR 10 in its entirety to be in a pluggable form factor. Because the modified BOSA 200 may comprise an optical transmitter 12 and/or an optical receiver 14, this desirable construction removes the need for fiber between e.g. the optical transmitter 12 and the circulator function 16, and/or between the photodiode 14.2 and the bandpass filter 14.1, and/or between the circulator function 16 and the bandpass filter 14.1.

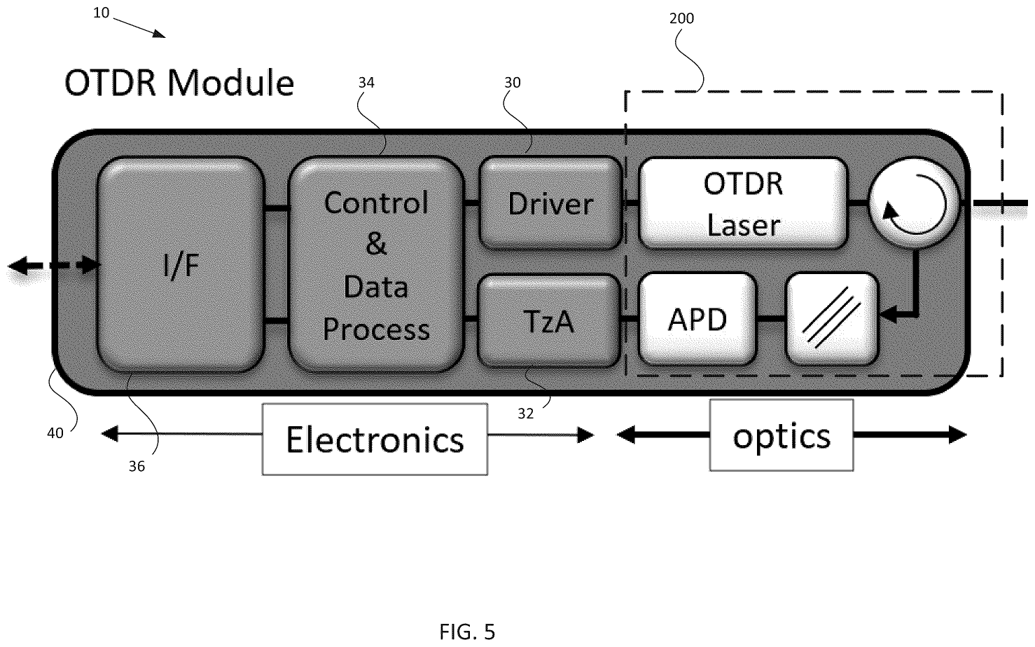

FIG. 5 shows an exemplary OTDR module 10 in accordance with various embodiments of the invention. There is shown a single module 40 comprising a modified BOSA 200, a driver circuit 30, a trans impedance amplifier 32, a processor element 34, and an electrical interface 36.

Because the modified BOSA 200 may be significantly smaller than the passive components as illustrated in FIG. 1 (comprising circulator 16, optical receiver 14, and optical transmitter 12), an entire OTDR module 10 may be integrated into a single module 40. The single module 40 may be an SFP/QSFP module, for example.

The modified BOSA 200 may comprise an optical transmitter 12 tuned to the substantially same frequency as the bandpass filter 14.1 and the photodetector 14.2. In accordance with various embodiments of the invention, a simplified modified BOSA 200 may also be envisaged, whereby the BOSA 200 would effectively comprise a circulator 16 and a bandpass filter 14.1 only, i.e. without the optical transmitter 12 and the photo diode 14.2.

FIG. 6 shows an alternative OTDR module 10 with a MSA interface 50. The MSA interface 50 (multi-source agreement interface) may define a form factor and interfaces for optical transceivers. MSA interface 50 may permit the OTDR module 10 to be communicatively coupled to other equipment, for example for further processing.

FIG. 7 depicts an alternative OTDR module 10 generating raw data. In FIG. 7, the processor element 34 may control the optical probe signal by a driver 30, and obtain the reflected measurement signals by a transimpedance amplifier 32. In contrast to a self-contained OTDR module, for example as previously illustrated, the processor element 34 outputs the raw data (or, in some instances, less processed data) to a host card 300 (via an interface, not labeled). The host card 300 may be operable to control and/or analyze data obtained from the OTDR module 10. In accordance with various embodiments of the invention, the host card 300 may allow more complex data analysis that may be processor-intensive on a small form factor pluggable OTDR module 10.

The present disclosure includes reference to certain examples, however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will include all examples falling within the scope of the appended claims.

What is claimed is:

1. An optical time domain reflectometer (OTDR) system comprising a modified BOSA, operable on a same transmit and receive frequency.

2. The OTDR of claim 1 wherein said OTDR comprises a single module, said single module being in a pluggable form factor.

3. The OTDR of claim 1 wherein said OTDR comprises a single output port coupled to a fibre link to be tested.

4. The OTDR of claim 1 wherein said OTDR comprises an MSA interface.

5. The OTDR of claim 2 wherein said pluggable form factor may be a QSFP format, a QSFP28 format, or an SFP format, or an OSFP format.

6. The OTDR of claim 1 wherein said modified BOSA comprises an optical circulator function or a coupler, and/or an optical bandpass function.

7. The OTDR of claim 6 wherein said modified BOSA comprises an optical transmitter and/or an optical receiver.

8. The OTDR of claim 7 wherein said optical transmitter is a laser and/or said optical receiver is a photo diode.

9. The OTDR of claim 2 wherein said single module is coupled to a host card for data analysis.

10. The OTDR of claim 1 wherein said OTDR comprises electrical process and control circuitry for analyzing the operation of a laser driver circuit and an output electrical voltage from a transimpedance amplifier and generating therefrom an OTDR trace as an output.
